(19) United States
(12) Patent Application Publication
(10) Pub. No.: US 2023/0401121 A1
(43) Pub. Date: Dec. 14, 2023

(54) FAULT LOG CLASSIFICATION METHOD AND SYSTEM, AND DEVICE AND MEDIUM

(71) Applicant: INSPUR SUZHOU INTELLIGENT TECHNOLOGY CO., LTD., Suzhou, Jiangsu (CN)

(72) Inventors: Yalun SUN, Jinan, Shandong (CN); Fang ZHANG, Jinan, Shandong (CN)

(21) Appl. No.: 18/033,779

(22) PCT Filed: Sep. 28, 2021
(86) PCT No.: PCT/CN2021/121437

§ 371 Date: Apr. 25, 2023

(30) Foreign Application Priority Data
Nov. 6, 2020 (CN) 202011231058.9

(51) Int. Cl. G06F 11/07

(52) U.S. Cl. CPC G06F 11/0787

(57) ABSTRACT

A fault log classification method, including the following steps: receiving a to-be-classified fault log, and determining, according to phrases containing most vocabularies in a preset corpus, a plurality of segmentation positions corresponding to the to-be-classified fault log; segmenting the to-be-classified fault log according to the corresponding plurality of segmentation positions to obtain a plurality of word groups; determining the weight of each word group according to the corpus and screening out a plurality of word groups according to the weights; and calculating the similarity between the to-be-classified fault log and each classified fault log by using a plurality of word groups screened out by a plurality of classified fault logs according to the weights and a plurality of word groups screened out by the to-be-classified fault log according to the weights, and then classifying the to-be-classified fault log according to the similarity.

### CROSS-REFERENCE TO RELATED APPLICATION

This application claims the priority of the Chinese Patent application filed on Nov. 6, 2020 before the China National Intellectual Property Administration with the application number of 202011231058.9, and the title of “FAULT LOG CLASSIFICATION METHOD AND SYSTEM, AND DEVICE AND MEDIUM”, which is incorporated herein in its entirety by reference.

### FIELD

The present application relates to the technical field of log processing and, more particularly, to a method for classifying fault logs, a system, a device and a storage medium.

### BACKGROUND

In the technology of monitoring a server, it is a very common and effective solution to analyze, predict and locate faults through the daily operation log of the server. The log file provides a large amount of information, and therefore, many algorithms are generated. For example, currently, there is a commonly used technical solution to classify the text by analyzing the log text, extracting the text features and establishing the text feature models. However, since the language of the server log data is English, there is a space between each two words in the English, using the text feature extraction to extract each key word may bring excessive data amount, over high feature vector dimension, and a large amount of calculation.

### SUMMARY

In view of this, in order to overcome at least one aspect of the problems stated above, the embodiments of the present application provides a method for classifying fault logs, including the following steps:
receiving a to-be-classified fault log, and determining, according to phrases containing most vocabularies in a preset corpus, a plurality of segmentation positions corresponding to the to-be-classified fault log;
segmenting the to-be-classified fault log according to the corresponding plurality of segmentation positions to obtain a plurality of word groups;
determining a weight of each word group according to the preset corpus and screening out a plurality of word groups according to the weights; and
calculating a similarity between the to-be-classified fault log and each classified fault log by using a plurality of word groups screened out by the plurality of classified fault logs according to the weights and a plurality of word groups screened out by the to-be-classified fault log according to the weights, and then classifying the to-be-classified fault log according to the similarity.

In some embodiments, the method further includes:
acquiring a plurality of historical fault logs, and screening out the plurality of word groups from each of the historical fault logs; and
forming a corpus based on a plurality of word groups of each of the historical fault logs.

In some embodiments, the method further includes:
calculating a term frequency and an inverse document frequency of each word group in the corpus; and
updating the word group whose term frequency is greater than a threshold to an obsolete word library, and calculating a weight of the word group whose term frequency is not greater than the threshold according to the term frequency and the inverse document frequency.

In some embodiments, receiving the to-be-classified fault log further includes:
according to the obsolete word library, deleting a corresponding word group in the to-be-classified fault log.

In some embodiments, determining, according to the phrases containing most vocabularies in the preset corpus, the plurality of segmentation positions corresponding to the to-be-classified fault log further includes:
determining a segmentation step M according to an amount of vocabularies in the phrases containing most vocabularies;
determining whether a word group composed of a current first vocabulary and an M^{th} vocabulary of the to-be-classified fault log is capable of matching with the word group in the corpus; and
in responding to that the word group composed of the current first vocabulary and the M^{th} vocabulary of the to-be-classified fault log is capable of matching with the word group in the corpus, after cutting front M vocabularies of the to-be-classified fault log, returning to the step of determining whether a word group composed of a current first vocabulary and an M^{th} vocabulary of the to-be-classified fault log after cut is capable of matching with the word group in the corpus.

In some embodiments, the method further includes:
in responding to that the word group composed of the current first vocabulary and the M^{th} vocabulary of the to-be-classified fault log is not capable of matching with the word group in the corpus, determining whether a word group composed of the current first vocabulary and an (M−1)^{th} vocabulary of the to-be-classified fault log is capable of matching with the word group in the corpus;
in responding to that the word group composed of the current first vocabulary and the (M−1)^{th} vocabulary of the to-be-classified fault log is capable of matching with the word group in the corpus, after cutting front M−1 vocabularies of the to-be-classified fault log, returning to the step of determining whether the word group composed of the current first vocabulary and the M^{th} vocabulary of the to-be-classified fault log after cut is capable of matching with the word group in the corpus;
in responding to that the word group composed of the current first vocabulary and the (M−1)^{th} vocabulary of the to-be-classified fault log is not capable of matching with the word group in the corpus, determining whether a word group composed of the current first vocabulary and an (M−N)^{th} vocabulary of the to-be-classified fault log is capable of matching with the word group in the corpus, wherein N refers to a number of iterations; and
in responding to that the word group composed of the current first vocabulary and the (M−N)^{th} vocabulary of the to-be-classified fault log is capable of matching with the word group in the corpus, after cutting front M-N vocabularies of the to-be-classified fault log, returning to the step of determining whether the word group composed of the current first vocabulary and the M^{th} vocabulary of the to-be-classified fault log after cut is capable of matching with the word group in the corpus.

In some embodiments, calculating the similarity between the to-be-classified fault log and each classified fault log by using the plurality of word groups screened out by the plurality of classified fault logs according to the weights and the plurality of word groups screened out by the to-be-classified fault log according to the weights further includes:
according to the plurality of word groups screened out by the plurality of classified fault logs according to the weights and the plurality of word groups screened out by the to-be-classified fault log according to the weights, obtaining a feature vector of each classified fault log and feature vectors of the to-be-classified fault log; and
calculating a similarity between the feature vector corresponding to each classified fault log and the feature vectors corresponding to the to-be-classified fault log.

On the basis of the same inventive concept, according to another aspect of the present disclosure, the embodiments of the present application further provide a system for classifying fault logs, including:
a receiving module configured for receiving a to-be-classified fault log, and determining, according to phrases containing most vocabularies in a preset corpus, a plurality of segmentation positions corresponding to the to-be-classified fault log;
a segmenting module configured for segmenting the to-be-classified fault log according to the corresponding plurality of segmentation positions to obtain a plurality of word groups;
a screening module configured for determining a weight of each word group according to the preset corpus and screening out a plurality of word groups according to the weights; and
a calculating module configured for calculating a similarity between the to-be-classified fault log and each classified fault log by using a plurality of word groups screened out by the plurality of classified fault logs according to the weights and a plurality of word groups screened out by the to-be-classified fault log according to the weights, and then classifying the to-be-classified fault log according to the similarity.

On the basis of the same inventive concept, according to another aspect of the present disclosure, the embodiments of the present application further provide a computer device, including:
one or more processors; and
a memory, a computer program that is capable of running on the processor stored in the memory, wherein the processor, when executing the computer program, implements the steps according to any one of methods stated above.

On the basis of the same inventive concept, according to another aspect of the present disclosure, the embodiments of the present application further provide a computer-readable storage medium, storing a computer program that is executed by a processor, and upon execution by the processor, is configured to cause the processor to implements the steps according to any one of methods stated above.

The present application has one of the following beneficial technical effects: by processing the English logs into the form of word groups and phrases, the vocabulary amount that needs to be processed in subsequent is greatly reduced, and the dimension of the feature word group is reduced, thus reducing the calculation amount of classifying the fault logs.

### BRIEF DESCRIPTION OF THE DRAWINGS

In order to explain the embodiments of the present application or the technical solutions in the prior art more clearly, a brief description will be given below with reference to the accompanying drawings which are used in the description of the embodiments or the prior art, and it is obvious that the drawings in the description below are merely some embodiments of the present application, and a person skilled in the art may obtain other embodiments according to these drawings without involving any inventive effort.

FIG. 1 is a flow chart of a method for classifying fault logs according to an embodiment of the present application;

FIG. 2 a schematic diagram showing the structure of a system for classifying fault logs according to an embodiment of the present application;

FIG. 3 is a schematic diagram showing the structure of a computer device according to an embodiment of the present application; and

FIG. 4 is a schematic diagram showing the structure of a computer-readable storage medium according to an embodiment of the present application.

### DETAILED DESCRIPTION

In order to make the objective, technical solution and advantages of the present application clearer, the embodiments of the present application are further described in detail by combining the embodiments and referring the drawings.

It should be noted that all expressions using “first” and “second” in the embodiments of the present disclosure are intended to distinguish two different entities or parameters with the same name. It may be seen that “first” and “second” are merely for the convenience of expressions and should not be understood as limiting the embodiments of the present disclosure, which will not be stated one by one in subsequent embodiments.

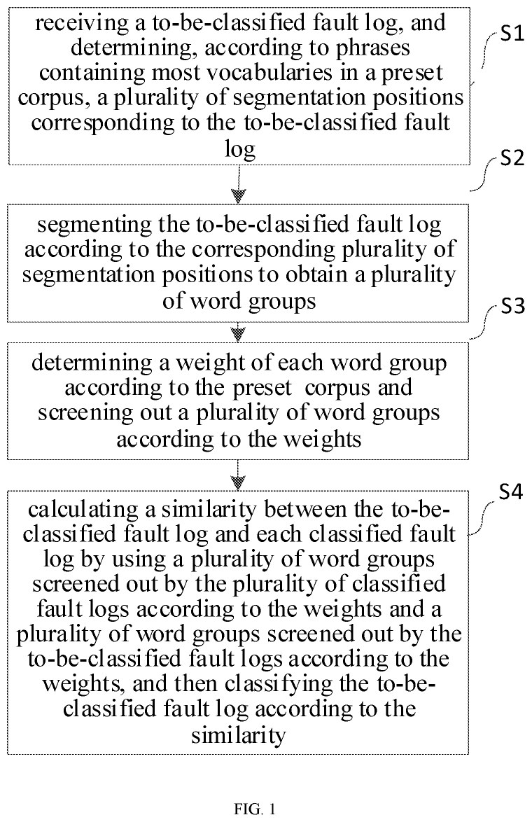

According to an aspect of the present disclosure, the embodiment of the present disclosure discloses a method for classifying fault logs. Referring to FIG. 1, the method may include steps as follows:
S1, receiving a to-be-classified fault log, and determining, according to phrases containing most vocabularies in a preset corpus, a plurality of segmentation positions corresponding to the to-be-classified fault log;
S2, segmenting the to-be-classified fault log according to the corresponding plurality of segmentation positions to obtain a plurality of word groups;
S3, determining a weight of each word group according to the preset corpus and screening out a plurality of word groups according to the weights; and
S4, calculating a similarity between the to-be-classified fault log and each classified fault log by using a plurality of word groups screened out by the plurality of classified fault logs according to the weights and a plurality of word groups screened out by the to-be-classified fault log according to the weights, and then classifying the to-be-classified fault log according to the similarity.

In the technical solution disclosed by the present application, by processing the English logs into the form of word groups and phrases, the vocabulary amount that needs to be processed in subsequent is greatly reduced, and the dimension of the feature word group is reduced, then the calculation amount of classifying the fault logs is reduced.

In some embodiments, the method further includes:
acquiring a plurality of historical fault logs, and screening out the plurality of word groups from each of the historical fault logs; and
forming a corpus based on a plurality of word groups of each of the historical fault logs.

In some embodiments, the corpus may be obtained by summarizing meaningful word groups or phrases in the logs by a user. The corpus may be assumed to be “sufficiently large”, which contains a set of word groups and phrases in all error log texts.

In some embodiments, the method further includes:
calculating a term frequency and an inverse document frequency of each word group in the corpus; and
updating the word group whose term frequency is greater than a threshold to an obsolete word library, and calculating a weight of the word group whose term frequency is not greater than the threshold according to the term frequency and the inverse document frequency’.

In some embodiments, the TFIDF algorithm may be used to calculate the term frequency and the inverse document frequency. The calculation formula may be as follows:

Term frequency calculation formula: the ratio of a vocabulary occurrence times to the total amount of words in the document.

$$T F = \frac{C ( x )}{C}$$

The inverse document frequency calculation formula is as follows:

$$IDF ( x ) = log \frac{N + 1}{N ( x ) + 1} + 1$$

Wherein N represents a total amount of corpus texts, and N(x) represents the total amount of texts containing the word x in the corpus.

By calculating the inverse document frequency of all word groups in the corpus, it may be obtained that a term frequency is too high means that the word group does not provide much information for text classification. Updating the obsolete word library according to the value of the term frequency, is to update word groups whose term frequency is greater than the threshold to the obsolete word library. The weights of the remaining word groups whose term frequency is not greater than the threshold may be obtained by multiplying the term frequency and the inverse document frequency. Then, the weights and the word groups are used to obtain a bag-of-word model, which is a two-dimensional table. The rows of the table represent all word groups and phrases contained in the corpus, the columns of the table represent a unit log of the corpus, and a single element in the bag-of-word model is the weight of a word group to the log or the weight of a phrase to the log.

In some embodiments, no matter whether the obsolete word library or the corpus may be updated. For example, after the plurality of historical fault logs are used to obtain the obsolete word library and the corpus, and after new fault logs are received, the plurality of new fault logs may be used to update the obsolete word library and the corpus.

In some embodiments, receiving the to-be-classified fault log further includes:
according to the obsolete word library, deleting a corresponding word group in the to-be-classified fault log.

In some embodiments, after receiving a log data packet, classifying (BIOS module, BMC module), pre-reading the log data, and processing the log text content may be performed according to the server and device module: deleting meaningless characters such as symbols and special characters, restoring the temporal changes of vocabulary to obtain the basic form of vocabulary, expanding abbreviations, removing stop words, extracting etyma, such as words leave, leafed, leafs and leafing, and unifying the log format of the modules. According to the word groups in the obsolete word library, some word groups that repeatedly appear multiple times but provide insufficient information amount are deleted, so that they are deleted before feature extraction, which may reduce the amount of data processing.

In some embodiments, users may set log reporting parameters in the system, the data collection module master of the management side issues commands to the slaves of the servers, and the slave reports error logs to the management side. The slave is a software running in the managed server host, which actively reports log data containing error information. The slave has the function of filtering, it screens out the normal operation log and reduces the amount of subsequent processing data. The user sets the slave reporting function through an interactive page: whether to report immediately, the reporting time cycle, the module contained in the reporting log, the level of the reporting log, for example, the slave is set to report logs of BIOS module and BMC module having errors exceeding the error level of fault at zero o'clock everyday. The second part is the master running on the server management side, which issues commands to the slave, receives the log data reported by the slave, and packages the data back to the system.

In some embodiments, determining, according to the phrases containing most vocabularies in the preset corpus, the plurality of segmentation positions corresponding to the to-be-classified fault log further includes:
determining a segmentation step M according to an amount of vocabularies in the phrases containing most vocabularies;
determining whether a word group composed of a current first vocabulary and an M^{th} vocabulary of the to-be-classified fault log is capable of matching with the word group in the corpus; and
in responding to that the word group composed of the current first vocabulary and the M^{th} vocabulary of the to-be-classified fault log is capable of matching with the word group in the corpus, after cutting front M vocabularies of the to-be-classified fault log, returning to the step of determine whether a word group composed of a current first vocabulary and an M^{th} vocabulary of the to-be-classified fault log after cut is capable of matching with the word group in the corpus.

In some embodiments, the method further includes:
in responding to that the word group composed of the current first vocabulary and the M^{th} vocabulary of the to-be-classified fault log is not capable of matching with the word group in the corpus, determining whether a word group composed of the current first vocabulary and an (M−1)^{th} vocabulary of the to-be-classified fault log is capable of matching with the word group in the corpus;
in responding to that the word group composed of the current first vocabulary and the (M−1)^{th} vocabulary of the to-be-classified fault log is capable of matching with the word group in the corpus, after cutting front M−1 vocabularies of the to-be-classified fault log, returning to the step of determining whether the word group composed of the current first vocabulary and the M^{th} vocabulary of the to-be-classified fault log after cut is capable of matching with the word group in the corpus;
in responding to that the word group composed of the current first vocabulary and the (M−1)^{th} vocabulary of the to-be-classified fault log is not capable of matching with the word group in the corpus, determining whether a word group composed of the current first vocabulary and an (M−N)^{th} vocabulary of the to-be-classified fault log is capable of matching with the word group in the corpus, wherein N refers to a number of iterations; and
in responding to that the word group composed of the current first vocabulary and the (M−N)^{th} vocabulary of the to-be-classified fault log is capable of matching with the word group in the corpus, after cutting front M−N vocabularies of the to-be-classified fault log, returning to the step of determining whether the word group composed of the current first vocabulary and the M^{th} vocabulary of the to-be-classified fault log after cut is capable of matching with the word group in the corpus.

In some embodiments, the amount of vocabularies in the word group containing the most vocabularies in the corpus is M. For the log text data, it may be cut with a greedy idea: a. firstly, the M vocabularies after the “current position” are segmented as a matching item; b. if the matching is successful, the “current position” is jumped to the segmentation position, and the remaining text is matched sequentially; c. if the matching fails, the M−1 vocabularies after the “current position” are segmented as a match item; d. if the matching is successful, performing the step b, if the matching fails, performing the step c, until all text is matched; e. outputting the text composed of a plurality of word groups.

For example, the to-be-classified fault log are a b c d e f g, M is 3, then the first segmentation position is between c and d, and then it is determined whether a b c may match the word groups in the corpus. If the matching is successful, d is used as the current first vocabulary, the second segmentation position is between f and g, and then it is determined whether d e f may match the word groups in the corpus, if not, it is determined whether d e may match the word groups in the corpus. If the matching is successful, the remaining text after re-segmentation is f g. If the matching fails, it is determined whether d may match the word groups in the corpus. If the matching is successful, the remaining text after re-segmentation is e f g.

It should be noted that each word group in the corpus contains at least one vocabulary, and if the word group in the corpus cannot match all vocabularies or word groups in the newly received fault log, the corpus needs to be updated according to the received new fault log.

In some embodiments, calculating the similarity between the to-be-classified fault log and each classified fault log by using the plurality of word groups screened out by the plurality of classified fault logs according to the weights and the plurality of word groups screened out by the to-be-classified fault log according to the weights further includes:
according to the plurality of word groups screened out by the plurality of classified fault logs according to the weights and the plurality of word groups screened out by the to-be-classified fault log according to the weights, obtaining a feature vector of each classified fault log and feature vectors of the to-be-classified fault log; and
calculating a similarity between the feature vector corresponding to each classified fault log and the feature vectors corresponding to the to-be-classified fault log.

In some embodiments, each classified fault log corresponds to one bag-of-word model, including the weights corresponding to all word groups. Then, a plurality of items with the greatest weight are selected to compose the key word groups of log data. After screening out key word groups from the to-be-classified fault log, and after removing duplicate items of all key word groups of the classified fault logs and the key word groups corresponding to the to-be-classified fault log, all of the remaining key word groups t₁, t₂, . . . , tᵢ are regarded as an n-dimensional coordinate system, and then each log is expressed as a vector in an n-dimensional space. The data structure of this vector is expressed as: {Dᵢ:[w₁,w₂, . . . wᵢ]}. Then, the similarities between vectors are calculated to classify the to-be-classified fault log.

For example, the key word groups of the to-be-classified fault log are a, b, c, d, e, and the key word groups of classified logs are a, b, c, a, c, f, c, e, g, so that all key word groups obtained after removing duplicate items are a, b, c, d, e, f, g, so that the vector corresponding to the to-be-classified fault log is (1,1,1,1,1,0,0). The vector corresponding to the classified log is (1,1,1,0,0,0,0), (1,0,1,0,0,1,0), (0,0,1,0,1,0,1), that is, the dimension of the vector is the same as all key word groups obtained after removing duplicate items. If the log includes the corresponding key word groups, the corresponding element value in the vector is 1, otherwise it is 0. It should be noted that the eigenvalues corresponding to the elements at the same position of all vectors are the same.

In the technical solution disclosed by the present application, by processing the English logs into the form of word groups and phrases, the amount of elements in the corpus is greatly reduced, thus the bag-of-word model is simplified and the dimension of the log feature vector is reduced.

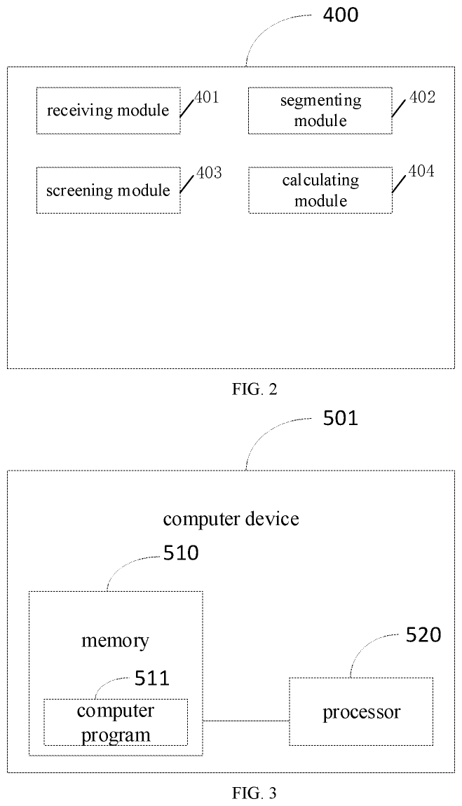

On the basis of the same inventive concept, according to another aspect of the present disclosure, the embodiments of the present application further provide a system 400 for classifying fault logs, referring to FIG. 2, the system 400 includes:
a receiving module 401 configured for receiving a to-be-classified fault log, and determining, according to phrases containing most vocabularies in a preset corpus, a plurality of segmentation positions corresponding to the to-be-classified fault log;
a segmenting module 402 configured for segmenting the to-be-classified fault log according to the corresponding plurality of segmentation positions to obtain a plurality of word groups;
a screening module 403 configured for determining a weight of each word group according to the preset corpus and screening out a plurality of word groups according to the weights; and
a calculating module 404 configured for calculating a similarity between the to-be-classified fault log and each classified fault log by using a plurality of word groups screened out by the plurality of classified fault logs according to the weights and a plurality of word groups screened out by the to-be-classified fault log according to the weights, and then classifying the to-be-classified fault log according to the similarity.

On the basis of the same inventive concept, according to another aspect of the present disclosure, the embodiments of the present application further provide a computer device 501, referring to FIG. 3, including:
one or more processors 502; and
a memory 501, a computer program 511 that is capable of running on the processor stored in the memory 501, wherein the processor 520, when executing the computer program, implements the steps according to any one of methods stated above.

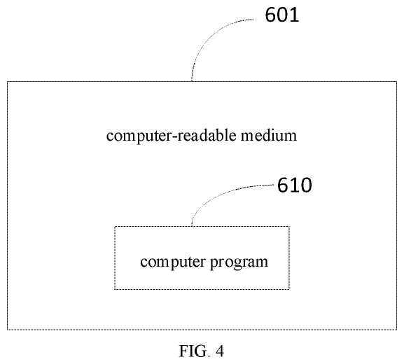

On the basis of the same inventive concept, according to another aspect of the present disclosure, referring to FIG. 4, the embodiments of the present application further provide a computer-readable storage medium 601, storing a computer program instruction 610 that is executed by a processor, and upon execution by the processor, is configured to cause the processor to implements the steps according to any one of methods stated above.

Finally, it should be noted that a person skilled in the art may understand all or a part of the process of implementing the method in the embodiment above, which may be completed by using the computer program to instruct related hardware. The program may be stored in a computer-readable storage medium. When the computer-readable instructions are executed, the processes of the embodiments of the methods may be included.

In addition, it should be understood that the computer-readable storage medium (e.g., memory) in this paper may be a volatile memory or a non-volatile memory, or may include both of the volatile memory and the non-volatile memory.

A person skilled in the art will also understand that various example logic blocks, modules, circuits, and algorithm steps described here may be implemented as electronic hardware, computer software, or a combination of both of the electronic hardware and the computer software. In order to clearly illustrate this interchangeability of hardware and software, a general description of the functions of various schematic components, blocks, modules, circuits and steps has been given. Whether this function is implemented as software or hardware depends on the application and the design constraints applied to the entire system. A person skilled in the art may implement functions in various ways for each application, but this implementation decision should not be interpreted as leading to a departure from the scope of the disclosure of the embodiments of the present application.

The above are exemplary embodiments of the present disclosure, but it shall be noted that various changes and modifications may be made without deviating from the scope of the embodiments of the present disclosure as defined by the appended claims. The functions, steps, and/or actions of the method claims according to the disclosed embodiments described herein need not be performed in any particular order. Furthermore, although elements according to the embodiments of the present disclosure may be described or claimed in the singular, the plural is contemplated unless limitation to the singular is explicitly stated.

It should be understood that, as used herein, the singular forms “a”, “an”, and “the” are intended to include the plural forms as well, unless the context clearly supports the exception. It should also be understood that the term “and/or” as used herein refers to any or all possible combinations including one or more associated listed items.

The serial number of the embodiments of the present disclosure is disclosed for description merely and does not represent the merits of the embodiments.

It may be appreciated by persons of ordinary skill in the art that all or part of the steps for implementing the above embodiments may be completed by hardware, or may be completed by instructing relevant hardware through a program. The program may be stored in a computer-readable storage medium, which may be a read-only memory, a magnetic disk or a compact disk, etc.

Persons of ordinary skill in the art will appreciate that the above discussion of any embodiment is intended to be exemplary merely, and is not intended to suggest that the scope (including the claims) of the embodiments of the present disclosure is limited to these examples; and combinations of features in the above embodiments or in different embodiments are also possible within the framework of the embodiments of the present disclosure, and many other variations of different aspects according to the embodiments of the present disclosure as described above are possible, which are not provided in detail for the sake of clarity. Therefore, any omission, modification, equivalent substitution, improvement, etc. made within the spirit and principles of the embodiments of the present disclosure shall fall within the scope of the embodiments of the present disclosure.

1. A method for classifying fault logs, comprising:
receiving a to-be-classified fault log, and determining, according to phrases containing most vocabularies in a preset corpus, a plurality of segmentation positions corresponding to the to-be-classified fault log;
segmenting the to-be-classified fault log according to the corresponding plurality of segmentation positions to obtain a plurality of word groups;
determining a weight of each word group according to the preset corpus and screening out a plurality of word groups according to the weights; and
calculating a similarity between the to-be-classified fault log and each classified fault log by using a plurality of word groups screened out by the plurality of classified fault logs according to the weights and a plurality of word groups screened out by the to-be-classified fault log according to the weights, and then classifying the to-be-classified fault log according to the similarity.

2. The method according to claim 1, wherein the method further comprises:
acquiring a plurality of historical fault logs, and screening out the plurality of word groups from each of the historical fault logs; and
forming a corpus based on a plurality of word groups of each of the historical fault logs.

3. The method according to claim 2, wherein the method further comprises:
calculating a term frequency and an inverse document frequency of each word group in the corpus; and
updating the word group whose term frequency is greater than a threshold to an obsolete word library, and calculating a weight of the word group whose term frequency is not greater than the threshold according to the term frequency and the inverse document frequency.

4. The method according to claim 3, wherein receiving the to-be-classified fault log further comprises:
according to the obsolete word library, deleting a corresponding word group in the to-be-classified fault log.

5. The method according to claim 1, wherein determining, according to the phrases containing most vocabularies in the preset corpus, the plurality of segmentation positions corresponding to the to-be-classified fault log further comprises:
determining a segmentation step M according to an amount of vocabularies in the phrases containing most vocabularies;
determining whether a word group composed of a current first vocabulary and an M^{th} vocabulary of the to-be-classified fault log is capable of matching with the word group in the corpus; and
in responding to that the word group composed of the current first vocabulary and the M^{th} vocabulary of the to-be-classified fault log is capable of matching with the word group in the corpus, after cutting front M vocabularies of the to-be-classified fault log, returning to the step of determining whether a word group composed of a current first vocabulary and an M^{th} vocabulary of the to-be-classified fault log after cut is capable of matching with the word group in the corpus.

6. The method according to claim 5, wherein the method further comprises:
in responding to that the word group composed of the current first vocabulary and the M^{th} vocabulary of the to-be-classified fault log is not capable of matching with the word group in the corpus, determining whether a word group composed of the current first vocabulary and an (M−1)^{th} vocabulary of the to-be-classified fault log is capable of matching with the word group in the corpus;
in responding to that the word group composed of the current first vocabulary and the (M−1)^{th} vocabulary of the to-be-classified fault log is capable of matching with the word group in the corpus, after cutting front M−1 vocabularies of the to-be-classified fault log, returning to the step of determining whether the word group composed of the current first vocabulary and the M^{th} vocabulary of the to-be-classified fault log after cut is capable of matching with the word group in the corpus;
in responding to that the word group composed of the current first vocabulary and the (M−1)^{th} vocabulary of the to-be-classified fault log is not capable of matching with the word group in the corpus, determining whether a word group composed of the current first vocabulary and an (M−N)^{th} vocabulary of the to-be-classified fault log is capable of matching with the word group in the corpus, wherein N refers to a number of iterations; and
in responding to that the word group composed of the current first vocabulary and the (M−N)^{th} vocabulary of the to-be-classified fault log is capable of matching with the word group in the corpus, after cutting front M-N vocabularies of the to-be-classified fault log, returning to the step of determining whether the word group composed of the current first vocabulary and the M^{th} vocabulary of the to-be-classified fault log after cut is capable of matching with the word group in the corpus.

7. The method according to claim 1, wherein calculating the similarity between the to-be-classified fault log and each classified fault log by using the plurality of word groups screened out by the plurality of classified fault logs according to the weights and the plurality of word groups screened out by the to-be-classified fault log according to the weights further comprises:
according to the plurality of word groups screened out by the plurality of classified fault logs according to the weights and the plurality of word groups screened out by the to-be-classified fault log according to the weights, obtaining a feature vector of each classified fault log and feature vectors of the to-be-classified fault log; and
calculating a similarity between the feature vector corresponding to each classified fault log and the feature vectors corresponding to the to-be-classified fault log.

8. (canceled)

9. A computer device, comprising:
one or more processors; and
a memory, a computer program that is capable of running on the processor stored in the memory, wherein the processor, when executing the computer program, implements the steps of the method according to claim 1.

10. A computer-readable storage medium, storing a computer program that is executed by a processor, and upon execution by the processor, is configured to cause the processor to implement the steps of the method according to claim 1.

11. The method according to claim 2, wherein the corpus is obtained by summarizing meaningful word groups or phrases in the historical fault logs.

12. The method according to claim 3, wherein the term frequency is a ratio of a vocabulary occurrence times to a total amount of words in a document.

13. The method according to claim 3, wherein a calculation formula of the inverse document frequency is:
$$IDF ( x ) = log \frac{N + 1}{N ( x ) + 1} + 1$$
wherein N represents a total amount of corpus texts, and N(x) represents a total amount of texts containing a word x in the corpus.

14. The method according to claim 3, wherein the weight of the word group whose term frequency is not greater than the threshold is obtained by multiplying the term frequency and the inverse document frequency.

15. The computer device according to claim 9, wherein the method further comprises:
acquiring a plurality of historical fault logs, and screening out the plurality of word groups from each of the historical fault logs; and
forming a corpus based on a plurality of word groups of each of the historical fault logs.

16. The computer device according to claim 15, wherein the method further comprises:
calculating a term frequency and an inverse document frequency of each word group in the corpus; and
updating the word group whose term frequency is greater than a threshold to an obsolete word library, and calculating a weight of the word group whose term frequency is not greater than the threshold according to the term frequency and the inverse document frequency.

17. The computer device according to claim 16, wherein receiving the to-be-classified fault log further comprises:
according to the obsolete word library, deleting a corresponding word group in the to-be-classified fault log.

18. The computer device according to claim 9, wherein determining, according to the phrases containing most vocabularies in the preset corpus, the plurality of segmentation positions corresponding to the to-be-classified fault log further comprises:
determining a segmentation step M according to an amount of vocabularies in the phrases containing most vocabularies;
determining whether a word group composed of a current first vocabulary and an M^{th} vocabulary of the to-be-classified fault log is capable of matching with the word group in the corpus; and
in responding to that the word group composed of the current first vocabulary and the M^{th} vocabulary of the to-be-classified fault log is capable of matching with the word group in the corpus, after cutting front M vocabularies of the to-be-classified fault log, returning to the step of determining whether a word group composed of a current first vocabulary and an M^{th} vocabulary of the to-be-classified fault log after cut is capable of matching with the word group in the corpus.

19. The computer device according to claim 18, wherein the method further comprises:
in responding to that the word group composed of the current first vocabulary and the M^{th} vocabulary of the to-be-classified fault log is not capable of matching with the word group in the corpus, determining whether a word group composed of the current first vocabulary and an (M−1)^{th} vocabulary of the to-be-classified fault log is capable of matching with the word group in the corpus;
in responding to that the word group composed of the current first vocabulary and the (M−1)^{th} vocabulary of the to-be-classified fault log is capable of matching with the word group in the corpus, after cutting front M−1 vocabularies of the to-be-classified fault log, returning to the step of determining whether the word group composed of the current first vocabulary and the M^{th} vocabulary of the to-be-classified fault log after cut is capable of matching with the word group in the corpus;
in responding to that the word group composed of the current first vocabulary and the (M−1)^{th} vocabulary of the to-be-classified fault log is not capable of matching with the word group in the corpus, determining whether a word group composed of the current first vocabulary and an (M−N)^{th} vocabulary of the to-be-classified fault log is capable of matching with the word group in the corpus, wherein N refers to a number of iterations; and
in responding to that the word group composed of the current first vocabulary and the (M−N)^{th} vocabulary of the to-be-classified fault log is capable of matching with the word group in the corpus, after cutting front M-N vocabularies of the to-be-classified fault log, returning to the step of determining whether the word group composed of the current first vocabulary and the M^{th} vocabulary of the to-be-classified fault log after cut is capable of matching with the word group in the corpus.

20. The computer device according to claim 9, wherein calculating the similarity between the to-be-classified fault log and each classified fault log by using the plurality of word groups screened out by the plurality of classified fault logs according to the weights and the plurality of word groups screened out by the to-be-classified fault log according to the weights further comprises:
according to the plurality of word groups screened out by the plurality of classified fault logs according to the weights and the plurality of word groups screened out by the to-be-classified fault log according to the weights, obtaining a feature vector of each classified fault log and feature vectors of the to-be-classified fault log; and
calculating a similarity between the feature vector corresponding to each classified fault log and the feature vectors corresponding to the to-be-classified fault log.

21. The computer-readable storage medium according to claim 10, wherein the method further comprises:
acquiring a plurality of historical fault logs, and screening out the plurality of word groups from each of the historical fault logs; and
forming a corpus based on a plurality of word groups of each of the historical fault logs.
